(19) United States
(12) Patent Application Publication
(10) Pub. No.: US 2004/0040595 A1
(43) Pub. Date: Mar. 4, 2004

(54) Power steering pump comprising cartridge flow control assembly

(75) Inventors: Bryan Youngpeter, Orion, MI (US); Dale C. Killins, Detroit, MI (US); Stephen T. Hung, Grosse Pointe, MI (US); Timothy M. Staton, Ypsilanti, MI (US); Scott L. Radabaugh, Ann Arbor, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/358,056

(22) Filed: Feb. 4, 2003

Related U.S. Application Data
(60) Provisional application No. 60/407,918, filed on Sep. 3, 2002.

(51) Int. Cl. F16K 17/04

(52) U.S. Cl. 137/115.13

(57) ABSTRACT

A power steering pump for an automotive power steering system or the like comprises a housing defining a bore and a fluid discharge port and a fluid bypass port communicating with the bore. A flow control assembly is received in the bore and comprises a cartridge that includes a first opening for admitting fluid from the fluid discharge port and a second opening communicating with the fluid bypass port. A flow control valve slides to open and close the fluid bypass port. The flow control valve is biased in the closed position by a coil spring and a retainer. During assembly of the flow control valve, the coil spring and the retainer within the cartridge, the spring compression force may be measured, and the position of the retainer adjusted, to obtain a predetermined opening force for the valve.

### RELATED APPLICATIONS

The present patent document claims the benefit of the filing date under 35 U.S.C. §119(e) of Provisional U.S. Patent Application Serial No. 60/407,918, filed Sep. 3, 2002, which is hereby incorporated by reference.

### TECHNICAL FIELD OF THE INVENTION

This invention relates to a power steering pump wherein the fluid output is controlled by recycling a portion of the pumped fluid through a bypass within the pump. More particularly, this invention relates to such power steering pump that includes a cartridge flow control assembly that may be readily installed in the pump housing and includes a pre-set flow control valve for regulating flow through the bypass.

### BACKGROUND OF THE INVENTION

A power steering system of an automotive vehicle comprises a pump for providing hydraulic fluid under pressure. A typical pump comprises a rotor having retractable vanes and rotating within a cam chamber. During operation, hydraulic fluid is drawn into the cam chamber from a fluid suction passage and pumped out under pressure to a fluid discharge port. The rotor is driven by the engine through a belt and a pulley. As the speed of the engine increases, the volume of fluid pumped by the rotor also increases. However, it is desired that the output from the pump remain relatively constant. This is accomplished by recycling a portion of the pumped fluid through a bypass in the pump housing, so that pumped fluid is diverted from the outlet and returned to the suction passage. At low engine speeds, the bypass is closed so that the entire volume of pumped fluid is outputted from the pump. However, at higher engine speeds, the bypass is open for recycling as much as 90 percent of the pumped fluid.

U.S. Pat. No. 5,887,612, issued to Bleitz et al. in 1999, shows a mechanism for opening and closing a fluid bypass port to regulate the output from the pump. For this purpose, the housing defines a bore that communicates with a fluid discharge port from the pumping chamber and with the fluid bypass port. The outlet from the pump is located at one end of the bore. Within the bore, a flow control valve slides to open and close the bypass port. The valve is biased in the closed position by a spring that is retained by a plug in the end of the bore opposite the outlet. At high engine speeds, the fluid pressure at the fluid discharge port acts upon the valve to contract the spring and open the bypass port.

It is found that deviations in the compression force of the spring as manufactured affects the pressure required for opening of the bypass port by the flow control valve and causes undesirable variations in the performance of the steering system. Because the pump comprises multiple components that are assembled directly into the pump housing, it is difficult to detect variations in performance or make adjustments to the spring force in the final assembly. In addition, the pump housing is typically formed of aluminum metal to reduce weight. Sliding of the relief valve against the aluminum surface of the bore causes wear that shortens the useful life of the pump. Still further, in the event that repair is needed, it is necessary to disassemble and reassemble the several components in the pump, adding significantly to the time and expense required for the repair.

Therefore, a need exists for a flow control assembly that can be readily installed in a power steering pump and provides a predetermined force for opening the bypass port by allowing the force required to open the flow control valve to be measured and adjusted prior to installation in the pump housing. There is also a need for reducing wear of the flow control assembly and thereby extending the useful life of the power steering pump. Still further, it is desired that, in the event that repair becomes necessary, the flow control assembly may be readily removed and replaced as a single component, thereby reducing the time and expense required to effect the repair.

### BRIEF SUMMARY OF THE INVENTION

In accordance with this invention, a power steering pump is provided that includes a housing defining a bore having an axis, a fluid discharge port communicating with the bore at a first axial location, and a fluid bypass port communicating with the bore at a second axial location. The power steering pump also includes a flow control assembly that is received in the bore. The flow control assembly comprises a cartridge defining a fluid outlet at one end through which pressurized fluid is supplied to the power steering system, and a passage communicating with the outlet. The cartridge includes a first opening communicating with the fluid discharge port for admitting fluid to the passage and a second opening communicating with the fluid bypass port for diverting fluid from the fluid outlet. A flow control valve is disposed within the cartridge and is axially slideable between a closed position wherein the valve closes the fluid bypass port from communication with the fluid discharge port, and an open position when the valve is axially withdrawn to provide fluid communication between the first opening and the second opening, thereby permitting fluid to flow through the passage from the fluid discharge port to the fluid bypass port. A coil spring is disposed within the cartridge for biasing the flow control valve in the closed position. A retainer is secured in the cartridge at a second end opposite the fluid outlet, so that the spring is interposed between the flow control valve and the retainer. It is an advantage of the flow control assembly that the force needed to open the flow control valve may be measured, and the position of the retainer adjusted, prior to securing the retainer in the cartridge. In this manner, the cartridge assembly of this invention compensates for variations in the coil spring and provides a predetermined pump output. After the opening pressure is set and the retainer is secured, the flow control assembly is readily installed in the pump housing as a single component, and, if necessary, replaced as a single component in repairing the pump.

### BRIEF DESCRIPTION OF THE DRAWINGS

This invention will be further described with reference to the following drawings wherein:

FIG. 1 is a cross-sectional view partially in schematic of a power steering pump, having a flow control assembly in accordance with this invention; and

FIG. 2 is a cross section of a portion of the power steering pump in FIG. 1, taken along line 2-2 in the direction of the arrows; and

FIG. 3 is a cross-sectional view of a portion of the power steering pump in FIG. 1, indicated by circle 3, showing the elements thereof in an open position.

### DETAILED DESCRIPTION OF THE INVENTION

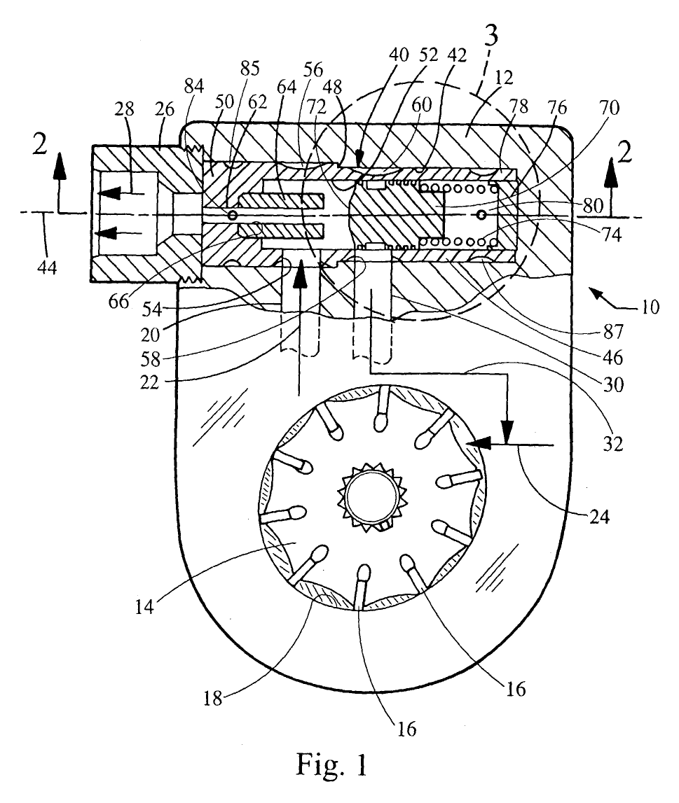

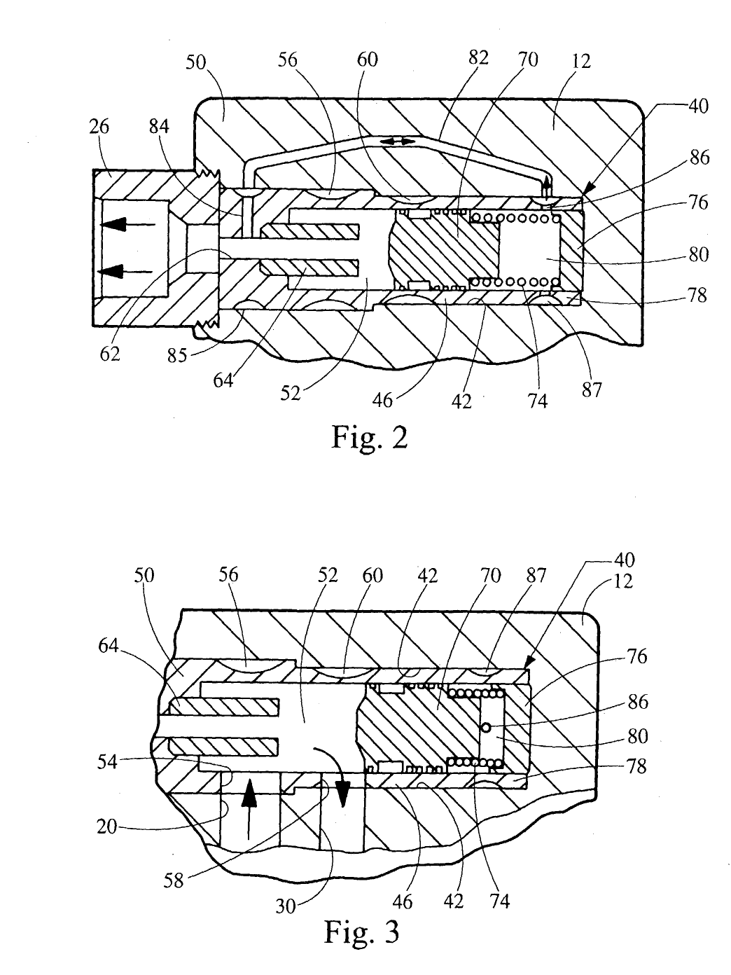

In accordance with the preferred embodiment of this invention, referring to FIGS. 1 and 2, there is depicted a power steering pump 10 for supplying pressurized fluid for a power steering system of an automotive vehicle. Pump 10 comprises a housing 12, preferably formed of an aluminum alloy. Housing 12 contains pumping elements, shown schematically, that include a rotor 14 that propels retractable vanes 16 within a cam chamber 18. Housing 12 defines a fluid discharge port 20 that discharges fluid under pressure from cam chamber 18, as indicated by arrow 22. The housing also defines a suction passage, indicated by arrow 24, for delivering fluid to cam chamber 18. During operation, rotor 14 is driven by the automotive engine via a belt and pulley arrangement. Fluid is pumped under pressure through discharge port 20 and exits through outlet adapter 26, as output 28. Outlet adapter 26 is connected through tubing to a rotary valve and steering gear of the power steering system. Fluid is returned to the pump through a return line (not shown) connected to suction passage 24 and is, in turn, drawn into cam chamber 18.

During operation, it is desired that the fluid output 28 remain at a substantially constant volume despite an increase in volume of pumped fluid resulting from higher engine speeds. For this purpose, a bypass port 30 is provided for recycling a portion of the pumped fluid to the suction passage 24, as indicated by arrow 32.

In accordance with this invention, pump 10 includes a flow control assembly 40 for regulating fluid flow through bypass port 30 and thereby regulating fluid output 28 from the pump. Flow control assembly 40 is received in a bore 42 in housing 12 that is symmetrical about an axis 44. Bore 42 communicates with fluid discharge port 20 at a first location and with bypass port 30 at a second location that is axially spaced from the first location.

Flow control assembly 40 comprises a cartridge 46 that is generally cylindrical about axis 44. Cartridge 46 comprises a shoulder 48 that engages a circumferential stop in bore 42 to position the flow control assembly within the bore, and is secured at one end 50, referred to as the outlet end, by outlet adapter 26. Cartridge 46 defines an axial fluid passage 52 that communicates with fluid discharge port 20 through an opening 54. Although FIG. 1 depicts opening 54 in registration with fluid discharge port 20, cartridge 46 includes a circumferential groove 56 to provide fluid communication between the opening and the discharge port regardless of the radial orientation of the cartridge in the bore. At the second location adjacent bypass port 30, an opening 58 is provided, along with a circumferential groove 60, for fluid communication between passage 52 and bypass port 30. At end 50, cartridge 46 defines an outlet passage 62 that communicates with outlet adapter 26. A flow control fitting 64 is fitted into end 50 and includes slots 66 for improved fluid flow control through the outlet under low flow conditions.

A flow control valve 70 is slideably disposed within the cartridge and includes a face 72 facing flow control fitting 64. Valve 70 is slideable between a closed position shown in FIG. 1 wherein valve 70 overlies bypass port 30 to prevent fluid communication with passage 52, and an open position shown in FIG. 2 wherein valve 70 is axially withdrawn relative to flow control fitting 64 and outlet end 50 to open opening 58 to bypass port 30. A suitable circumferential seal is provided between cartridge 46 and valve 70 by lands and grooves in the perimeter of the valve. A coil spring 74 extends between valve 70 and a retainer 76 secured in end 78 of cartridge 46 opposite outlet end 50. Spring 74 biases valve 70 in the closed position shown in FIG. 1. Also, cartridge 46 and retainer 76 cooperate with valve 70 to define a pressure sensing chamber 80 axially opposite valve 70 from fluid passage 52. Referring to FIG. 2, housing 12 defines a fluid pressure sensing passage 82 that communicates at one end with outlet passage 62 through an orifice 84 and circumferential groove 85, and at the other end with fluid pressure sensing chamber 80 through an orifice 86 and a circumferential groove 87.

The power steering system is designed to operate at low engine speeds using an output 28 from pump 10 that is equal to the volume of pumped fluid discharged from cam chamber 18 by rotor 14 and retractable vanes 16. Under these conditions, valve 70 is biased by spring 74 in the closed position to close bypass port 30, so that the entire output from the pumping elements flows through outlet passage 62 and outlet adapter 26. At higher engine speeds, the faster rotation of rotor 14 increases the volume of fluid discharged from cam chamber 18 through fluid discharge port 20 into passage 52 within cartridge 46. Fluid flow from passage 52 to outlet 28 is restricted by the size of outlet passage 62. Fluid pressure within chamber 52 increases and acts upon face 72 to contract spring 74 and slide valve 70 into the open position. As the fluid pressure in chamber 52 opens valve 70, the fluid pressure in chamber 80 is relieved through passage 82. When valve 70 is retracted, excess fluid flows from chamber 52 through bypass port 30 and into suction passage 24 en route to cam chamber 18.

It is a main advantage of this invention that valve 70 and spring 74 are assembled in cartridge 46 prior to installation into housing 12. In a preferred embodiment, retainer 76 is fixed to cartridge 46 by swaging. During the assembly process, valve 70, spring 74 and retainer 76 are inserted into cartridge 46 through end 78. Prior to swaging, the force required to compress spring 74 and open valve 70 is measured, and the position of retainer 76 is adjusted to set the opening force at a predetermined value. After the opening force is set, end 78 is swaged to secure retainer 76. Thereafter, assembly 40 may be readily tested, for example, by installing into a test pump or suitable fixture, to verify the desired opening pressure. Thus, proper operation of flow control assembly 40 may be assured when assembly 40 is installed into a pump for vehicle use. Alternately, the retainer may be threadedly mounted in the cartridge end, or may be adjusted and secured by other joining techniques such as soldering or welding.

It is also an advantage of this invention that flow control assembly 40 is installed into housing 12 as a single component, thereby facilitating the final assembly of the pump and reducing the cost associated therewith. In the event that repair becomes necessary, the flow control assembly may be readily removed and replaced as a single component. Moreover, the cartridge and the valve are preferably formed of steel or other wear resistant metal. This reduces wear due to sliding of the valve against the cartridge, particularly in comparison to a valve sliding against an aluminum surface of the housing, and thereby extends the useful life of the pump.

While this invention has been described in terms of certain embodiments thereof, it is not intended to be so limited, but rather only to the extent set forth in the claims that follow.

1. A power steering pump comprising:
a housing defining a bore having an axis, a fluid discharge port communicating with the bore at a first axial location, and a fluid bypass port communicating with the bore at second axial location;
a cartridge received in the bore and having a fluid outlet at a first end and a passage communicating with the fluid outlet, a first opening communicating with said fluid discharge port for admitting fluid to the passage, and a second opening communicating with the fluid bypass port for diverting fluid from the fluid outlet;
a flow control valve disposed in the cartridge and axially slideable between a closed position wherein the flow control valve closes the fluid bypass port from communication with the fluid discharge port and an open position wherein the valve is axially withdrawn relative to the first opening and the second opening to provide fluid communication therebetween;
a coil spring engaging the flow control valve opposite the fluid outlet; and
a retainer secured in the cartridge and engaging said coil spring spaced from the flow control valve, whereby the coil spring and the retainer cooperate to bias the flow control valve in the closed position.

2. A power steering pump in accordance with claim 1 wherein the retainer cooperates with the cartridge to define a pressure sensing chamber opposite the flow control valve from the fluid outlet, and wherein the coil spring is received in the pressure sensing chamber.

3. A power steering pump in accordance with claim 1 wherein the cartridge, the flow control valve, the coil spring and the retainer are pre-assembled in a flow control assembly that is installed into the bore of the housing.

4. A power steering pump in accordance with claim 1 wherein the cartridge comprises a circumferential groove extending about the cartridge at the first opening.

5. A power steering pump in according with claim 1 wherein the cartridge comprises a circumferential groove extending about the cartridge at the second opening.

6. A power steering pump in accordance with claim 1 wherein the retainer is threadedly secured in a second end of the cartridge opposite the first end.

7. A power steering pump in accordance with claim 1 wherein the retainer is disposed in a second end of the cartridge opposite the first end, and wherein the second end is swaged to secure the retainer.

8. A power steering pump in accordance with claim 1 wherein the cartridge includes a first orifice adjacent the first end and a second orifice adjacent the second end, and wherein the housing further defines a pressure sensing passage communicating with the first orifice and the second orifice.

9. A power steering pump in accordance with claim 1 further comprising an outlet adapter mounted in an end of the bore and securing the cartridge within the bore.

10. A power steering pump comprising:
a housing defining a bore having an axis, a fluid discharge port communicating with the bore at a first axial location, a fluid bypass port communicating with the bore at second axial location, a fluid pressure sensing passage communicating with the bore at third axial location and a fourth axial location;
a cartridge received in the bore and having a fluid outlet at a first end, a passage adjacent the fluid outlet, and a second end apart from the fluid outlet, said cartridge comprising a first opening communicating with said fluid discharge port for admitting fluid to the passage, a second opening communicating with the fluid bypass port for returning fluid from the passage, a first orifice at said fluid outlet communicating with the fluid pressure sensing passage at the third location and a second orifice communicating with the fluid pressure sensing passage at the fourth location;
a flow control valve slideably received within the cartridge, said flow control valve being slideable between a closed position wherein the valve closes the second opening and an open position wherein the valve is axially withdrawn relative to the first opening and the second opening to provide fluid communication through the passage between the fluid discharge port and the fluid bypass port;
a retainer secured in the second end and cooperating with the cartridge to define a fluid pressure sensing chamber that communicates with the second orifice; and
a coil spring received in said fluid pressure sensing chamber and engaging the flow control valve and the retainer for biasing the flow control valve in the closed position.

11. A power steering pump in accordance with claim 10 further comprising a flow control fitting disposed at the fluid outlet adjacent the passage.

12. A power steering pump in accordance with claim 10 wherein the power steering pump further comprises a cam chamber and a rotor having retractable vanes and rotatably disposed within the cam chamber.

13. A power steering pump in accordance with claim 10 wherein the second end of the cartridge is swaged to secure the retainer.

14. A power steering pump in accordance with claim 10 wherein the retainer is threadedly secured in the second end of the cartridge.

15. A power steering pump in accordance with claim 10 wherein the cartridge comprises a circumferential groove at the first opening.

16. A power steering pump in accordance with claim 10 wherein the cartridge comprises a circumferential groove at the second opening.

17. A power steering pump in accordance with claim 10 further comprising an outlet adapter mounted in the housing at one end of the bore and securing the cartridge within the bore.
